(19) United States
(12) Patent Application Publication
(10) Pub. No.: US 2023/0226488 A1
(43) Pub. Date: Jul. 20, 2023

(54) EXHAUST GAS TREATMENT SYSTEM

(71) Applicants: JOHNSON MATTHEY PUBLIC LIMITED COMPANY, London (GB); JOHNSON MATTHEY CATALYSTS (GERMANY) GmbH, Redwitz an der Rodach (DE)

(72) Inventors: Joseph FEDEYKO, Wayne, PA (US); Kenneth KOEHLER, Audubon, PA (US); Dirk REICHERT, Redwitz an der Rodach (DE); Thomas Manning YEH, Audubon, PA (US)

(21) Appl. No.: 18/069,636

(22) Filed: Dec. 21, 2022

Related U.S. Application Data
(60) Provisional application No. 63/266,802, filed on Jan. 14, 2022.

(51) Int. Cl. B01D 53/86; B01D 53/26; B01D 53/04; B01D 53/06; B01D 53/34

(52) U.S. Cl. CPC B01D 53/8634; B01D 53/261; B01D 53/0438; B01D 53/06; B01D 53/343; B01D 2257/304; B01D 2257/55; B01D 2257/80; B01D 2257/406; B01D 2253/108; B01D 2253/102; B01D 2259/4009; B01D 2255/911

(57) ABSTRACT

There is provided an exhaust system for the treatment of a humid exhaust gas comprising ammonia in an amount of up to 250 ppm, the system comprising: a dehumidifier system comprising a humid air inlet for providing a flow of humid exhaust gas; an exhaust gas inlet for providing a flow of dehumidified exhaust gas; an ammonia storage material arranged to receive the dehumidified exhaust gas from the exhaust gas inlet; an ammonia oxidation catalyst arranged downstream of a selected portion of the ammonia storage material; and a heating device for heating gas before it passes through the selected portion of the ammonia storage material to release ammonia stored therein for treatment on the ammonia oxidation catalyst; wherein the system is configured so that the selected portion of the ammonia storage material changes over time; and wherein the flow of dehumidified exhaust gas provided by the exhaust gas inlet is received from the dehumidifier system.

The present invention relates to a system and method for the treatment of an exhaust gas and, in particular, for the treatment of a humid exhaust gas comprising relatively low concentrations of ammonia which need to be treated. The system is particularly useful for treating emissions of ammonia produced from livestock houses which are at low and variable concentrations.

Animals are often reared in a relatively small space such as a barn, coop, or shed (generally “house”). This confined space can potentially lead to undesirably high concentrations of pollutants in the contained gas atmosphere of a space housing livestock. Typical pollutants include NH₃, VOCs, H₂S, bioaerosols such as organic or inorganic particulates which can arise from feed and manure particles and may include bacteria, and the like. Therefore, air quality within the barn is a concern for both animal and workers health. Furthermore, emissions ventilated to the outside can cause problems and may be subject to emissions limits.

For example in poultry rearing, it is required that NH₃ should be limited in the poultry breathing air to 25 ppm (OSHA in the US). While this is attainable, concentrations as high as 50-200 ppm are also known. Emissions typically are not constant and increase with number, age and activity of the animals (VDI 4255 part 2).

For animal breeding, the air exchange rate in the barn/house depends on the outside temperatures. In summer exchange rates may be high, whereas in colder whether it typically is very low to avoid generating too much of a draft, which can impact animal health. A low air exchange rate worsens the pollutant concentrations in the air which the animals/workers breathe.

There is a particular focus at the moment on decreasing the pollutant concentrations inside of the barn and also emission to the outside. The current state-of-the-art to minimise these organic and inorganic air pollutants relies on scrubber and biofilter systems which have an associated high investment cost. In operation a relatively high volume of fresh water is used and therefore a high volume of organically-polluted grey water is attained.

CN11113567 describes a rotating bed of sorbent material so as to better saturate the entirety of the bed without wasting unused sorbent. Once the sorbent material is saturated it is discarded and replaced.

EP 2581127 A1 relates to a method of air purification whereby pollutants, preferably VOCs, are broken down by means of UV radiation, preferably by means of photooxidation and residual pollutants may be oxidised by a catalytic converter.

EP 1930065 relates to a treatment assembly for VOC gases including two or more treatment units.

KR 20180035351 relates to an ammonia removal apparatus and method.

DE 202006002505 relates to a compact system for cleaning VOC-contaminated exhaust air streams, the application of which is suitable for both low and high emission concentrations.

KR 20130052393 relates to an energy-saving volatile organic compound removal device and volatile organic compound removal method using the same.

KR 20120082163 relates to a method for treating waste gas simultaneously containing odours and contaminants such as volatile organic compounds.

Accordingly, it is desirable to provide an improved system and method for treating such exhaust gases and/or to tackle at least some of the problems associated with the prior art or, at least, to provide a commercially viable alternative thereto. Exhaust gases from livestock houses and buildings comprising HVAC systems, for example, comprise water/moisture such that there remains a need for the abatement of pollutants which are present in humid exhaust gases. In particular, it is an aim to achieve catalytic destruction of ammonia directly in the gas phase for recirculation of the air back to the inside or venting to the outside.

According to a first aspect there is provided an exhaust system for the treatment of a humid exhaust gas comprising ammonia in an amount of up to 250 ppm, the system comprising: a dehumidifier system comprising a humid air inlet for providing a flow of humid exhaust gas;
an exhaust gas inlet for providing a flow of dehumidified exhaust gas;
an ammonia storage material arranged to receive the dehumidified exhaust gas from the exhaust gas inlet;
an ammonia oxidation catalyst arranged downstream of a selected portion of the ammonia storage material; and
a heating device for heating gas before it passes through the selected portion of the ammonia storage material to release ammonia stored therein for treatment on the ammonia oxidation catalyst;
wherein the system is configured so that the selected portion of the ammonia storage material changes over time; and
wherein the flow of dehumidified exhaust gas provided by the exhaust gas inlet is received from the dehumidifier system.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The following discussion focuses in particular on the treatment of ammonia from poultry houses (including chicken sheds), but it should be appreciated that the invention applies equally to other livestock environments (such as swine houses) and to other situations where low concentrations of ammonia need to be treated.

The present invention allows for the direct catalytic treatment of ammonia in the gas phase. In particular, the invention provides for treatment of ammonia in low concentrations and at low temperature directly in the gas phase of a humid exhaust gas without the use of a liquid phase like in scrubber or biofilter systems. The low temperature catalytic gas treatment system can operate with only electrical power for fans and gas heaters and does not have any constantly-incurred by-products except for spent sorbent material or catalyst.

Direct treatment of a low temperature exhaust gas with a catalyst tends to have a low conversion efficiency. Known catalysts tend to operate more effectively at temperatures well above ambient. To make the input of energy to heat the exhaust gas efficient, it is not desirable to treat large volumes of exhaust gases with low ammonia concentration levels. The inventors have now found that the system and method described herein overcome these problems. In particular, the concentration of the ammonia to be treated can be significantly increased so that the heated catalyst is only required to treat a smaller volume of contaminant-rich exhaust gas.

The inventors have found that they can apply technologies generally used in the automobile exhaust field, such as ammonia oxidation catalysts and ammonia storage beds, to treat low level exhaust concentrations. This system is particularly advantageous for treating gases which are provided at low temperatures (such as at or around ambient) and at low concentrations (even down to 10 s of ppm). Since existing known components can be used which are already available on a mass-production scale, the production costs of the system described herein can be significantly reduced.

Moreover, the system permits a continuous flow of ammonia to be treated on a catalyst, despite the natural variance in the levels which are being produced.

The present invention relates to an exhaust system for the treatment of an exhaust gas comprising ammonia. Specifically, the present invention relates to an exhaust system for the treatment of a humid exhaust gas comprising ammonia, the system comprising a dehumidifier system and configured so that a selected portion of an ammonia storage material arranged to receive the humid exhaust gas and absorb ammonia changer over time.

In a particularly preferred embodiment of the present invention, the ammonia storage material is provided within a rotating sorbent bed. Accordingly, the general system will be described further herein under the heading “wheel system”. Also described herein a preferred embodiments of the dehumidifier system of the exhaust system. In one embodiment described under the section heading “dehumidifier wheel system”, the dehumidifier system is based on equivalent features as described herein under the “wheel system” and such features may extend equally to that of the “dehumidifier wheel system” unless the context clearly indicates otherwise. A further embodiment of the dehumidifier is described under the section heading “dehumidifier valve system”.

The dehumidifier system is arranged upstream of the ammonia storage material and ammonia oxidation catalyst and provides a flow of dehumidified exhaust gas to the remainder of the exhaust system by dehumidifying a humid exhaust gas comprising the ammonia. The dehumidifier comprises a humid air inlet for providing a flow of humid exhaust gas (such as an exhaust gas from a livestock house comprising ammonia). The dehumidifier provides a flow of dehumidified exhaust gas to the exhaust gas inlet of the exhaust system of the invention.

The exhaust system comprises a dehumidifier system for removing water independently of other gases. By removing water from, for example, livestock house air, ventilation and water concentration can be decoupled. Through the decoupling of water from livestock house air, energy savings, particularly in cooler temperatures, can be increased by reducing the air purge from the house while the water vapour concentration still remains at a low enough level where livestock health and value are not impacted.

By selectively removing water (in addition to the ammonia in a separate step), the amount of purged air can be reduced, meaning less fresh air is required to be brought in the house which results in lower heating costs.

The inventors have found that the moisture content of an exhaust gas inhibits the mechanism of the other treatment systems. For example, moisture has been found to reduce catalyst performance by blocking active sites. In terms of heating efficiency, the inventors have also found that increased energy was required to heat humid exhaust gas reducing the overall efficiency of the system.

The exhaust gas inlet, ammonia storage material, ammonia oxidation catalyst and heating device of the exhaust system will now be further described under the section heading “wheel system” and therefore relates to the section of the exhaust system downstream of the dehumidifier system for the treatment of the ammonia.

### Wheel System

An exhaust gas is a gas to be emitted or discharged. In the context of the present invention, the exhaust gas is a humid gas containing a build-up of ammonia which needs to be treated to ensure that emissions limits are met, or to ensure that an internal environment is kept at tolerable levels in view of health and safety considerations. In the context of a livestock house (for example, a poultry house or a swine house), the exhaust gas is the air within the house which contains ammonia produced by animals, which is taken out of the house to be processed within the exhaust gas system described herein, either to be emitted to the outside or recycled into the house atmosphere.

The exhaust system is for the treatment of humid exhaust gas comprising ammonia in an amount of up to 250 ppm. Preferably the humid exhaust gas comprises from 1 to 50 ppm ammonia, preferably 5 to 30 ppm and most preferably 10 to 25 ppm ammonia. That is, the system is preferably for the treatment of a humid exhaust gas comprising ammonia in such amounts. As noted above, ammonia levels in poultry houses are limited to not exceeding 20 ppm, so the gas exhausted from such houses will have less than 20 ppm ammonia which needs to be treated. The present device and apparatus provide an efficient approach to treating such low levels of ammonia.

The ppm concentrations of the ammonia will of course fluctuate because of the natural source of the ammonia. The above ranges for concentrations are the average concentrations over the operating period of the exhaust gas system, excluding any start-up or warm-up period required for the system.

Preferably the system comprises one or more fans to push or pull gases through the system. The configuration of such a fan will depend on the desired air exchange rate required in the atmosphere to be treated. Advantageously the entire system can be driven by a single fan.

The system comprises an exhaust gas inlet. This will be the air-intake for providing a flow of dehumidified exhaust gas. The exhaust gas (i.e. humid exhaust gas) is taken from an atmosphere containing ammonia to be treated (source gas), such as a livestock house atmosphere. The exhaust gas may be drawn into the inlet with a fan, and typically involves a conventional air intake within, for example, a livestock house air handling system.

The exhaust gas inlet will provide gas at the ambient temperature of the source gas. In the context of a livestock house, this will typically be from 10 to 40° C. Preferably the humid exhaust gas entering the system and/or the dehumidified exhaust gas entering the exhaust gas inlet is at ambient temperature. Preferably the exhaust gas will be at 5 to 60° C., preferably at 5 to 50° C., more preferably 10 to 40° C. and most preferably 20 to 30° C. The temperature of the ambient air in the house may be controlled with heating and/or cooling. In general, for certain animals it may not be necessary to provide heating in winter.

The system comprises an ammonia storage material arranged to receive dehumidified exhaust gas from the exhaust gas inlet. Preferably the ammonia storage material comprises a zeolite or activated carbon, such as activated charcoal. Suitable ammonia storage materials are well known in the field of automobile exhaust gas treatment systems.

Zeolites are constructed of repeating SiO₄, AlO₄, tetrahedral units linked together, for example in rings, to form frameworks having regular intra-crystalline cavities and channels of molecular dimensions. The specific arrangement of tetrahedral units (ring members) gives rise to the zeolite's framework, and by convention, each unique framework is assigned a unique three-letter code (e.g., “CHA”) by the International Zeolite Association (IZA). Zeolites may also be categorised by pore size, e.g. a maximum number of tetrahedral atoms present in a zeolite's framework. As defined herein, a “small pore” molecular sieve, such as CHA, contains a maximum ring size of eight tetrahedral atoms, whereas a “medium pore” molecular sieve, e.g. MFI, contains a maximum ring size of ten tetrahedral atoms; and a “large pore” molecular sieve, such as BEA, contains a maximum ring size of twelve tetrahedral atoms.

A most preferred zeolite for the storage of ammonia is a small-pore zeolite. Small pore zeolites are more selective for ammonia and so may reduce competition for ammonia storage when other gaseous species are present. Preferably the small-pore zeolite has a framework structure selected from the group consisting of AEI, AFT, AFV, AFX, AVL, CHA, EMT, GME, KFI, LEV, LTN, and SFW, including mixtures of two or more thereof. It is particularly preferred that the zeolite has a CHA or AEI-type framework structure.

The zeolite may be in its H+-form or may be loaded (for example, ion-exchanged) with a metal. Copper and/or iron loading is particularly preferred. Where a metal-loaded zeolite is employed, the zeolite may have a metal-loading in the range 1 to 6 wt %, preferably 3-5.5 wt % and most preferably about 4 wt %.

These sorbent materials are used to accumulate the material to be stored under normal flow conditions but when heated release the stored material. In this way the ammonia is concentrated on the solid storage material before being released into the gas phase in a more concentrated form.

The ammonia storage material may preferably be disposed on a suitable substrate such as a honeycomb monolith, a corrugated substrate (such as corrugated glass-paper or quartz fibre sheet), or a plate. Alternatively, the sorbent material (storage material) itself may be extruded in the form of a monolith or in the form of pellets or beads. For example, the sorbent material may comprise a packed bed of sorbent bead material. The nature of the sorbent material will depend on the backpressure requirements of the system.

Most preferably the ammonia storage material comprises one or more zeolites or activated carbon. Preferably the sorbent material comprises a mixture of two or more zeolites. These may be provided in a zoned configuration with different zeolites in different regions of the storage material.

In one embodiment the ammonia storage material may be provided with a material suitable for the storage of volatile organic compounds (VOC). The storage and treatment of VOCs may allow for the odour of a livestock house to be ameliorated, as well as avoiding any associated health risks.

Volatile organic compounds can also be present in livestock house environments, either released from the animals or their environment (including feed and bedding). VOCs are defined by the WHO, as cited in ISO 16000-6, as any organic compound whose boiling point is in the range from (50° C. to 100° C.) to (240° C. to 260° C.), corresponding to having saturation vapour pressures at 25° C. greater than 102 kPa. VOCs include alcohols, aldehydes, amines, esters, ethers, hydrocarbons (up to about C10), ketones, nitrogen-containing compounds, phenols, indoles and other aromatic compounds, terpens and sulphur containing compounds. These are discussed in “characterisation of odour released during handling of swine slurry: Part I. Relationship between odorants and perceived odour concentrations” Blanes-Vidal et. al. Atmospheric Environment 43 (2009) 2997-3005, incorporated herein by reference.

The material suitable for the storage of volatile organic compounds (VOC) may be the same material for the storage of ammonia, or a further material may be provided which has better storage performance for VOCs than ammonia. For example, a suitable material for the storage of a VOC would be a medium or large pore zeolite. Therefore, a mixture (in a mixed, zoned or layered configuration) of a small pore zeolite (for ammonia) and a medium/large pore zeolite (for VOCs) could be provided. Examples of preferred large pore zeolites include zeolite Y and Beta. In such embodiments the VOCs will be released at the same time and decomposed with the same oxidation catalyst. This may require higher catalyst temperatures than for ammonia alone.

Accordingly, in a preferred embodiment the ammonia storage material is provided together with a VOC storage material, wherein the ammonia storage material comprises a small pore zeolite and wherein the VOC storage material comprises a medium or large pore zeolite. Preferably the ammonia storage material and the VOC storage material are provided as a mixture, or in distinct zones, or in layers. For zoned configurations one material will be upstream of the other.

The system comprises an ammonia oxidation catalyst arranged downstream of the selected portion of the ammonia storage material (i.e. downstream of the portion of the ammonia storage material which receives heated gas to cause desorption of ammonia). Materials known for use in ammonia oxidation catalysts are well known and would be suitable here. The catalyst may comprise one or more PGMs, for example and may have a layered or zoned configuration. Zoned and layered embodiments (preferably on a single substrate) may be preferred if a separate catalyst is desired to treat VOCs from the catalyst needed to treat ammonia.

Consequently, the present invention is particularly effective as a catalyst as described herein may be used to convert the ammonia into essentially nitrogen gas (N₂) and water (H₂O). On the contrary, known systems such as for VOC oxidation based on UV oxidation with ozone and photolysis result in the complete oxidation of any nitrogen present in the exhaust stream which leads to the generation of harmful nitrogen oxides (NOₓ) which is advantageously avoided using the present system.

Accordingly, it is preferred that the exhaust system does not comprise a photoreactor, a means for generating UV light or a means for generating ozone. It follows that the method preferably does not comprise photolysis or ozonolysis (i.e. suppling ozone for the oxidation of the species).

The system comprises a heating device for heating gas before it passes through the selected portion of the ammonia storage material to release ammonia stored therein for treatment on the ammonia oxidation catalyst. There are a number of specific configurations of heater discussed below, but the primary consideration is that the heater should provide a flow of hot gas to pass through the ammonia storage material and release the accumulated ammonia. The heater is configured to heat only gas going through a selected portion, so only the ammonia on that portion is released. That is, exhaust gas which does not pass through the selected portion of the ammonia storage material is not heated by the heater and therefore remains at ambient temperature. This means that a significant amount of ammonia can be released at a higher concentration in the flow of heated gas through the ammonia storage material. This increases the efficiency of the treatment.

One benefit of the invention is that the releasable storage achieved in the ammonia storage material permits concentration of the ammonia. Preferably the concentration of the ammonia passed to the catalyst is at least 2 times greater than the initial exhaust gas, preferably at least 5 times and more preferably at least 10 times greater, still more preferably at least 20 times greater. In embodiments which store ammonia and VOCs, these will also be released simultaneously.

The selected portion of the ammonia storage material will preferably be at most 50% of the ammonia storage material. However, preferably the selected portion will be from 1 to 15%, preferably 5 to 10% of the ammonia storage material. When the ammonia storage material is a rotating sorbent bed as discussed below, the selected portion will be a sector extending from the central axis. The size of the selected portion determines the proportion of the ammonia storage material which is discharging ammonia and the portion which is charging; preferably there is at least 5 times more of the ammonia storage material charging than discharging.

Preferably the heating device is configured to heat the dehumidified gas before it passes through the selected portion of the ammonia storage material to a temperature of from 50 to 300° C., preferably 100 to 250° C. and most preferably 150 to 200° C. The target temperature will depend on the heat needed to release stored ammonia from the downstream ammonia storage material.

The heater is intended to heat only the selected portion so that the remainder of the ammonia storage material can continue to accrue ammonia from the gas flow. The air which is being heated may be obtained from the exhaust gas inlet, from a recycled air duct as discussed below, or from fresh air taken from a fresh air inlet. There are advantages to drawing in fresh air since this avoids contacting contaminants with the source of heat. For example, if an electrical induction heater is used, this can become degraded with airborne contaminants during use.

In one configuration of the heating device, it is located between the exhaust gas inlet and the ammonia storage material. A simplest configuration would therefore be the provision of a resistive heater coil arranged to heat a flow of passing gas, with the coil arranged to only heat the gas passing on to the selected portion. Such a heater can be electrical as mentioned above, or based on combustion of a fuel. Preferably the heater is a gas burner, preferably a propane, natural gas or biogas burner. These are useful especially for locations such as livestock houses, since there tend to be available supplies of propane and the like on such sites. In one embodiment, propane may be supplied with gas recycled from an outlet downstream of the ammonia oxidation catalyst as an oxygen source for combustion. Such an afterburner serves to further purify the gas being treated.

Preferably, the flow of heated gas is heated with heat obtained from the catalytic treatment of the species. By recycling the heat obtained from the exothermic decomposition of the species, the system can be maintained in an autothermal condition. In other words, the system can operate continuously without requiring any input of heat from an external heater but solely from the heat generated by the catalytic decomposition further improving the efficiency of system. This is particularly effective where the flow of heated exhaust gas is portion of the dehumidified exhaust gas as the inventors found that the absence of moisture increased the efficiency of heating the exhaust gas. Accordingly, with improved energy recycling, sufficient heat may be retained from the catalytic treatment and transferred to exhaust gas to be treated so as to maintain autothermal conditions.

In another configuration the heating device may be located between the ammonia storage material and the ammonia oxidation catalyst and wherein the system further comprises a duct for recycling at least a portion of the gas treated on the ammonia oxidation catalyst to upstream of the selected portion of the ammonia storage material. That is, the system can recycle some of the gas passing out of the ammonia oxidation catalyst to a position upstream of the selected portion of the ammonia storage material to provide the heated flow of gas.

Alternatively, the heating device may be a heat exchanger arranged to recover heat from gas downstream of the ammonia oxidation catalyst. In this embodiment the gas passing out of the ammonia oxidation catalyst is not physically recycled, but it has its heat recovered by the heat exchanger and is used to heat a portion of gas passing to the selected portion of the ammonia storage material. By using such a heat exchanger, the inventors have found that a further heater upstream of the selected portion of the ammonia storage material is not required such that, preferably, there is no further heater upstream of the selected portion of the ammonia storage material (i.e. for heating gas entering the ammonia storage material). Nevertheless, it may be preferable that a second heating device is located between the ammonia storage material and the ammonia oxidation catalyst and is configured to heat gas passing to the ammonia oxidation catalyst to 200 to 300° C.

The system is configured so that the selected portion of the ammonia storage material changes over time. This means that there is one portion of the ammonia storage material which is being discharged of ammonia, while a remainder (one or more further portions) of the ammonia storage material is being charged with ammonia. Since the selected portion changes over time, each portion will have a first time period when it is charging with ammonia and a second time period when it is discharging the ammonia.

It should of course be appreciated that the above configuration is contemplated for the system when in operation, whereas during start-up or under certain conditions it may be required that all of the ammonia storage material is storing the ammonia (i.e. the heater is not being used to heat gas passing to the selected portion) so that there is a sufficient quantity to be treated.

Various configurations of the system can be envisioned whereby the selected portion of the ammonia storage material changes over time. In each instance the selected portion needs to move relative to the supply of heated gas and relative to the ammonia oxidation catalyst arranged downstream of the selected portion of the ammonia storage material (both of which must move together so that the heated gas desorbs ammonia from the storage material which is then treated by the catalyst). Given the complexity of the ducting and the simplicity of the ammonia storage material (such as a sorbent bed), it will generally be most appropriate to move the ammonia storage material.

A particularly preferred arrangement to allow for the selected portion of the ammonia storage material to change over time is for the ammonia storage material to be configured as a rotating sorbent bed. That is, preferably the ammonia storage material is provided within a sorbent bed which is arranged to rotate so that, in use, different portions of the ammonia storage material are each contacted with a heated gas in turn.

For a rotating sorbent bed, the bed can preferably be configured to rotate continuously at a constant rate. Alternatively, the bed can be configured to rotate stepwise at pre-set, preferably uniform, intervals (a “revolver cylinder” type configuration). Continuous rotation is preferred since this avoids any step in the ammonia release and oxidation and since this reduces wear on the system components. Typical rotation rates, in either rotation configuration, will be in the region of 0.5 to 4 rotations per hour, preferably about 1 rotation per hour. A suitable rotation rate will depend on the ammonia levels in the exhaust gas and the size of the bed and can be tuned to the specific application. A primary consideration is that the wheel needs to rotate at a sufficiently slow rate such that it cools for effective storage of ammonia before it is heated again for ammonia release. Indeed, the rotation rate can be changed on the fly responsive to ammonia levels in the exhaust gas. For example, at night when ammonia levels from a livestock house will typically decline, the wheel can rotate more slowly, speeding up in the day when the system can benefit from solar power, for example. The heater can also be turned off for a period to allow ammonia levels to increase in the storage material if required.

Preferably the system further comprises one or more ammonia sensors downstream of the remainder of the ammonia storage material, i.e. not downstream of the selected portion, to determine an ammonia loading status. This can be used to control the rotation rate to ensure that ammonia storage material is discharged before it becomes over full. By the term “ammonia sensor” it is meant any sensor that is capable of providing an indication of ammonia loading levels. A preferred sensor is an automotive NO, sensor since these are not expensive and cannot distinguish between NH₃ and NO, (i.e. where only NH₃ is present the output of the NOₓ sensor gives an indication of NH₃ levels). Such sensors are well known in the art.

For a rotating sorbent bed the preferred bed size is such that it has a diameter of from 10 cm to 600 cm, preferably 100 to 450 cm, more preferably 200 to 400 cm, for example 300 cm. Preferably, the sorbent bed has a depth of 5 to 50 cm, preferably 10 to 20 cm. As will be appreciated, the rotating beds can therefore have a significant ammonia storage capacity. The size of the wheel can be scaled down or up depending on a number of factors, for example, the quantity of ammonia (larger animals will generate higher quantities) and the back-pressure generated (which itself will be dependent on a variety of factors, e.g. sorbent depth, fan size). The main factor in the wheel size is the pressure-drop requirements, with larger wheel sizes permitting lower pressure drop requirements, meaning less powerful 15 driving fans are required with an associated lower energy cost. A wheel size of 2-4 m can permit a pressure drop as low as 2 mbar or even 1 mbar.

Gas flow rates through the system would be expected to peak in the region of 100 to 300 km³/h, such as about 200 km³/h, with faster rates required in summer than in winter.

As can be appreciated from a rotating sorbent bed, the bed will have a portion receiving the dehumidified ambient air from the, for example, a poultry house, at an ambient temperature. This portion of the bed will be efficiently storing ammonia. The selected portion receiving heated gas will be at an elevated temperature as mentioned above, such as 150° C. However, a portion which has just been rotated away from the source of heated gas will take time to cool to ambient temperature. During this period there is an increased risk of ammonia slip.

Preferably, the system comprises means for cooling a previously-heated portion of the ammonia storage material with a supply of ambient air. The ambient air may be ambient dehumidified exhaust gas, for example from the livestock house. In some embodiments, it is preferred that the ambient air is ambient fresh air. In a particularly preferred embodiment, the supply of ambient air can be coupled with a heat exchanger to allow use of the heat being recovered elsewhere in the system. That is, heat from the previously-heated portion of the ammonia storage material may be recovered through the use of an ambient air flow which is then further heated, preferably using a heat exchanger arranged to recover heat from gas downstream of the ammonia oxidation catalyst as described herein, so as to provide the heated gas (i.e. a separate gas stream) which passes through the selected portion of the ammonia storage material. Preferably the previously-heated portion of the ammonia storage material is cooled with a flow counter to the normal direction of gases through the ammonia storage material. This means that the gas flow avoids any ammonia slip, since any ammonia is carried back upstream of the cooling ammonia storage material and is either retained on ambient temperature ammonia storage material, or passes through the selected portion as a heated gas (depending on the configuration).

Equally, a portion of the sorbent bed that is soon to be the selected portion can be preheated to be brought up to temperature. This can advantageously be achieved by diverting a residual flow of heated gas through this portion of the sorbent bed or by using a heat-exchanger to pre-heat using secondary heat sources elsewhere in the process. Preferably the system comprises means for ducting gas from a previously-heated portion of the ammonia storage material to pre-heat a soon-to-be heated portion of the ammonia storage material. Gases leaving the soon-to-be-heated portion of the ammonia storage material may slip ammonia, so desirably this gas is then heated further (heater or heat exchanger) and ducted upstream of the selected portion to provide the required flow of heated gas. Such pre-heating has been found to provide an effective means for recycling heat within the exhaust system and improving overall efficiency. For example, heat is recycled from the previously-heated portion to the soon-to-be heated portion of the ammonia storage material and the gas used to transfer such heat, together with any residual heat after pre-heating the soon-to-be-treated portion and ammonia slip, may then be heated via a heat exchanger arranged to recover heat from gas downstream of the ammonia oxidation catalyst. As described herein, the heated gas is then passed through the selected portion of the ammonia storage material.

The rotating sorbent bed can comprise a plurality of inserts comprising the ammonia storage material. This means that suitable ammonia storage materials that can be employed are those of the types known from the automotive industry, saving in cost and complexity. In such an embodiment the plurality of inserts would be releasably held in a supporting frame structure so as to provide storage material for the exhaust gas to pass through while minimising any gas bypassing the storage material.

Preferably the system further comprises one or more material filters between the exhaust gas inlet and the ammonia storage material. That is, the system comprises filters to perform an initial screen of matter which could affect the performance of the downstream exhaust system. When treating air from a poultry house, such a material filter can be used to remove entrained feathers, fluff, straw, dust and the like. Accordingly, it is preferred that the system comprises one or more material filters to pre-filter the humid exhaust gas thereby removing matter prior to the dehumidifier system.

Preferably the system comprises an H₂S sorbent material and/or an arsenic sorbent material upstream of the ammonia storage material, preferably upstream of the dehumidifier system and water storage material. Sulphur or arsenic poisoning of the ammonia storage material or the ammonia oxidation catalyst would lead to a drop in system performance, so it is desirable to separately capture this upstream within the system. Preferably the system further comprises one or more sorbent materials for further contaminants upstream of the plurality of sorbent beds, wherein the further contaminant is selected from one or more of SO₂, SO₃, Hg and Cl. By Hg and CI it is meant any suitable mercury-containing and chlorine-containing species, respectively. Such contaminants are dlsirably removed in order to ensure that the one or more catalysts are not poisoned.

As noted above, the ammonia storage material will be selected to store ammonia at the ambient temperature of the received exhaust gas. In order to release the ammonia stored in the ammonia storage material the temperature of the gas passing through the selected portion of the ammonia storage material is increased. A suitable temperature for stimulating the ammonia release may be in the region of about 150° C. as discussed above. However, this may not be the optimal temperature for the operation of the ammonia oxidation catalyst. Accordingly, the system may further comprise a second heating device located between the ammonia storage material and the ammonia oxidation catalyst and, preferably the second heating device is configured to heat gas passing to the ammonia oxidation catalyst to 200 to 300° C.

This is particularly advantageous because the oxidation of the ammonia is itself exothermic. Accordingly, the second heater may only be required intermittently to activate the ammonia oxidation catalyst when it cools below an optimal operating temperature. It is more efficient to adopt this approach, rather than simply heating all of the gas passing through the selected portion of the ammonia storage material to the temperature required by the catalyst, since the ammonia can be released at a much lower temperature.

One or more of the filters, sorbent beds or catalysts described herein may comprise copper. Copper is known to have an antiviral effect. Thus, the presence of the copper in the system to contact the exhaust gas may have an antiviral effect which could reduce transmission of viruses via the exhaust gas. For example, a zeolite included in the ammonia storage material (or the VOC storage material where present) may comprise copper. Such copper may be loaded by ion exchange onto the zeolite. Preferably the copper-loading of the zeolite is in the range from 1 to 6 wt % of the zeolite.

According to a further aspect there is provided a complete system comprising both the source of the exhaust gas system to be treated and the exhaust system as described herein. According to a further aspect there is provided a livestock house comprising the exhaust-gas system as described herein.

According to a further aspect there is provided a method of treating a humid ammonia-containing exhaust gas, the method comprising passing the humid ammonia-containing exhaust gas through the exhaust-gas system as described herein.

### Dehumidifier Valve System

In one preferred embodiment of the dehumidifier system, the dehumidifier system comprises:
a humid air inlet for providing a flow of humid exhaust gas;
a further gas inlet for providing a further flow of heated gas, preferably heated external air;
a plurality of water-sorbent beds, comprising a water storage material, for releasably storing water;
a further gas outlet in fluid communication with the first gas inlet;
an external gas outlet; and
a dehumidifier valve system configured to establish independently for each water-sorbent bed fluid communication in a first or second dehumidifier configuration, wherein:
   i) in the first dehumidifier configuration the flow of the humid exhaust gas from the humid air inlet contacts a water-sorbent bed for storing water and then passes to the further gas outlet; and
   ii) in the second dehumidifier configuration the further flow of heated gas from the further gas inlet contacts a water-sorbent bed for releasing the water to form a heated humidified gas which then passes to the external gas outlet;
wherein the dehumidifier valve system is configured to ensure that at least one water-sorbent bed is in the first dehumidifier configuration and, preferably at least one other water-sorbent bed is in the second dehumidifier configuration.

The dehumidifier system comprises a humid air inlet for providing a flow of humid exhaust gas. The humid air inlet provides the exhaust gas to be treated. The exhaust gas (i.e. humid exhaust gas) is taken from an atmosphere containing a species to be treated, such as a livestock house. The exhaust gas may be drawn into the inlet with a fan, and typically involves a conventional air intake within, for example, a livestock house air handling system.

The system comprises a further gas inlet for providing a further flow of heated gas. However, it will be appreciated that the further flow of heated gas is not untreated, ammonia laden exhaust gas. Preferably, the further gas inlet draws in fresh air from outside of the system. However, the further gas inlet may make use of the treated exhaust gas after decomposition of the ammonia. Similarly, the further gas inlet may preferably incorporate a heating device for providing the flow of heated gas to the water storage material, particularly where the gas is fresh air.

The volume of gas passing through the further gas inlet may be reduced compared to the volume of gas passing through the humid air inlet. That is, a majority of gas may be used to charge the sorbent beds, but the volume of gas being used to discharge a sorbent bed is preferably reduced to minimise the gas volume to be heated so as to desorb the water from the water storage material. Preferably the gas flow through the second gas inlet is at most defined by the total gas volume through the system divided by the number of sorbent beds in the system, and most preferably from 0.5 to 1, more preferably 0.6 to 0.8 times this value.

The humid air inlet will provide gas at the ambient temperature of the source gas. In the context of a livestock house, this will typically be from 10 to 40° C. as described herein.

The further gas inlet provides a flow of heated gas, such that the further gas inlet provides gas that is hotter than the gas from the humid air inlet. The system is therefore configured so that the flow of exhaust gas from the humid air inlet is at a temperature suitable for storage on the sorbent bed, whereas the flow of heated gas from the further gas inlet is at a higher temperature and is suitable for causing the release of at least a portion of the water on the sorbent bed. That is, the water is then desorbed from the water-sorbent bed with a smaller volume of heated gas than the volume of gas from which it has been recovered.

Preferably the further gas inlet incorporates a heating device for providing the flow of heated gas. Preferably the heating device is configured to provide a flow of gas at a temperature of from 100 to 600° C., preferably 100 to 350° C., preferably 150 to 200° C. The target temperature will depend on the heat needed to release the water from the downstream water-sorbent bed.

The heater can be electrical or based on combustion of a fuel. Preferably the heater is a gas burner, preferably a propane, natural gas or biogas burner. These are useful especially for locations such as livestock houses, since there tend to be available supplies of propane and the like on such sites. In one embodiment, propane may be supplied with gas from the first and/or second exhaust gas outlet as an oxygen source for combustion. Such an afterburner serves to further purify the gas being treated.

Preferably, the flow of heated gas is heated with heat obtained from the catalytic treatment of the ammonia. By recycling the heat obtained from the exothermic decomposition, the system can be maintained in an autothermal condition. In other words, the system can operate continuously without requiring any input of heat from an external heater but solely from the heat generated by the catalytic decomposition further improving the efficiency of system.

The system comprises a plurality of water-sorbent beds, the beds comprising a water storage material, for releasably storing water.

The water-sorbent material may preferably be disposed on a suitable substrate such as a honeycomb monolith, a corrugated substrate (such as corrugated glass-paper or quartz fibre sheet) or a plate. Alternatively, the sorbent material (storage material) itself may be extruded in the form of a monolith or in the form of pellets or beads. For example, the sorbent material may comprise a packed bed of sorbent bead material. The nature of the sorbent material will depend on the backpressure requirements of the system.

The number of sorbent beds required will depend on the size of the sorbent beds and the humidity of the exhaust gas to be treated. It may, for example, be desirable to have a large number of sorbent beds, but only have a subset in use. This will allow the capacity of the system to scale, for example to scale with animals as they grow and produce more water.

The dehumidifier system comprises a further gas outlet in fluid communication with the exhaust gas inlet, and an external gas outlet. Where the majority of the exhaust gas passing through the sorbent bed and having had the ammonia removed is then released to the atmosphere, the further gas outlet of the dehumidifier system for receiving the majority of the dehumidified exhaust gas instead directs the exhaust gas to the first gas inlet so that the species contained therein can be treated. Accordingly, the further gas outlet is for gas flowing past (passing through) the water storage material so that the gas passing out of the outlet has had the water of the humid exhaust gas adsorbed onto the water storage material. Such dehumidified exhaust gas retains the species to be treated and the further gas outlet is therefore provided in fluid communication with the first gas inlet.

Unlike ammonia, water is non-toxic and the heated humidified gas does not need to be treated before being released to the atmosphere. A flow of heated gas (which does not comprises any species to be treated; preferably heated external air) is used to contact and pass through the water storage material as required so as to release the water stored therein. This forms a heated humidified gas which then passes to the external gas outlet and to the atmosphere. This regenerates the water storage material so that the humid exhaust gas may continue to be dehumidified. As described herein, it is preferred that heat is recovered from the heated humidified gas.

The dehumidifier system comprises a dehumidifier valve system configured to establish independently for each water-sorbent bed fluid communication in a first or second dehumidifier configuration, wherein:
i) in the first dehumidifier configuration the flow of the humid exhaust gas from the humid air inlet contacts a water-sorbent bed for storing water and then passes to the further gas outlet; and
ii) in the second dehumidifier configuration the further flow of heated gas from the further gas inlet contacts a water-sorbent bed for releasing the water to form a heated humidified gas which then passes to the external gas outlet.

The dehumidifier valve system is configured to ensure that at least one water-sorbent bed is in the first dehumidifier configuration and preferably at least one other water-sorbent bed is in the second dehumidifier configuration. As will be appreciated, the first dehumidifier configuration will result in the water being stored within the water-sorbent bed, whereas the second dehumidifier configuration will result in the water being released from the water-sorbent bed.

In general use the dehumidifier valve system will be configured to ensure that at least one water-sorbent bed is in the first dehumidifier configuration and at least one other water-sorbent bed is in the second dehumidifier configuration. It should of course be appreciated that this configuration is contemplated for the system when in operation, whereas during start-up or under certain conditions it may be that all of the water-sorbent beds are in the first dehumidifier configuration in the absence of a need to regenerate the water storage material of a bed and whilst the rest of the exhaust system reaches a steady state of operation.

Preferably the dehumidifier valve system is further configured to establish independently for each water-sorbent bed fluid communication a third dehumidifier configuration for cooling of the water-sorbent bed, wherein gases are prevented from leaving the sorbent bed. This is a desirable option because it prevents a circumstance whereby the sorbent bed is connected to the further gas outlet but is still releasing water. In an embodiment with three beds there would be one bed discharging, one bed cooling and one bed recharging, or one bed discharging and two beds recharging.

Preferably the humid exhaust gas passing into the dehumidifier system through the humid air inlet comprises from 1 to 5000 ppm of the species (i.e. equivalent to that described herein with regard to the dehumidified exhaust gas).

Preferably the dehumidifier system comprises one or more fans to push or pull gases through the system. The configuration of such a fan will depend on the desired air exchange rate required in the atmosphere to be treated. Such fans may also serve to push or pull gas through the remainder of the “wheel system” described herein.

Preferably the dehumidifier system further comprises one or more humidity sensors in communication with each sorbent bed to determine a water loading status.

### Dehumidifier Wheel System

In another preferred embodiment wherein the dehumidifier system is configured so that the selected portion of the water storage material changes over time (referred to herein generally as the “dehumidifier wheel system”), the dehumidifier system comprises:
a humid air inlet for providing a flow of humid exhaust gas;
a water storage material arranged to receive the humid exhaust gas from the humid air inlet;
a further gas outlet for receiving dehumidified exhaust gas passing through the water storage material, which is in fluid communication with the first gas inlet;
an external gas outlet arranged downstream of a selected portion of the water storage material; and
a further gas inlet for providing a further flow of heated gas, preferably heated external air, arranged to pass through the selected portion of the water storage material to release water stored therein and to form a heated humidified gas which passes through the external gas outlet.

The dehumidifier system comprises a humid air inlet. This will be the air-intake for providing a flow of humid exhaust gas (source gas). The humid air inlet provides the humid exhaust gas to be treated. The exhaust gas may be drawn into the inlet with a fan, and typically involves a conventional air intake within, for example, a livestock house air handling system.

The humid air inlet will provide gas at the ambient temperature of the source gas as described above. The temperature of the ambient air in the house may be controlled with heating and/or cooling. In general, for certain animals it may not be necessary to provide heating in winter.

The system comprises a water storage material arranged to receive the humid exhaust gas from the humid air inlet.

As described for the “dehumidifier valve system” the water storage material may preferably be disposed on a suitable substrate such as a honeycomb monolith, a corrugated substrate (such as corrugated glass-paper or quartz fibre sheet), or a plate. Alternatively, the sorbent material (storage material) itself may be extruded in the form of a monolith or in the form of pellets or beads. For example, the sorbent material may comprise a packed bed of sorbent bead material. The nature of the sorbent material will depend on the backpressure requirements of the system.

The “dehumidifier wheel system” comprises a further gas outlet equivalent to that described above for the “dehumidifier valve system”. The further gas outlet receives dehumidified exhaust gas from gas flowing past (passing through) the water storage material so that the gas passing out of the outlet has had the water of the humid exhaust gas adsorbed onto the water storage material. Equally, the further gas outlet is in fluid communication with the first gas inlet of the exhaust system.

Furthermore, the “dehumidifier wheel system” further comprises an equivalent further gas inlet for providing a further flow of heated gas. A flow of heated gas (which does not comprises any species to be treated; preferably heated external air) is used to contact and pass through a selected portion of the water storage material, as required so as to release the water stored therein. This forms a heated humidified gas which then passes to the external gas outlet and to the atmosphere. This regenerates the selected portion of the water storage material so that the humid exhaust gas may continue to be dehumidified using an equivalent mechanism as that described herein for the treatment of ammonia whereby the selected portion of the water storage material changes over time.

The system preferably comprises a heating device for heating gas before it passes through the selected portion of the water storage material to release water stored therein for release to the atmosphere. The heater is configured to heat only gas going through a selected portion, so only the water on that portion is released. That is, the humid exhaust gas does not pass through the selected portion of the ammonia storage material is not heated by the heater and therefore remains at ambient temperature for water absorption.

The selected portion of the water storage material will preferably be at most 50% of the water storage material. However, preferably the selected portion will be from 1 to 15%, preferably 5 to 10% of the water storage material. When the water storage material is a rotating sorbent bed as discussed below, the selected portion will be a sector extending from the central axis. The size of the selected portion determines the proportion of the water storage material which is discharging water and the portion which is charging; preferably there is at least 5 times more of the water storage material charging than discharging.

Preferably the heating device is configured to heat the gas before it passes through the selected portion of the water storage material to a temperature of from 50 to 300° C., preferably 100 to 250° C. and most preferably 150 to 200° C. The target temperature will depend on the heat needed to release stored water from the downstream water storage material.

The heater is intended to heat only the selected portion so that the remainder of the water storage material can continue to accrue water from the humid exhaust gas flow. The air which is being heated may be fresh air taken from a fresh air inlet as described above.

In one configuration the heating device may be located between the water storage material and the one or more catalysts and wherein the system further comprises a duct for recycling at least a portion of the gas treated on the catalyst to upstream of the selected portion of the water storage material. That is, the system can recycle some of the gas passing out of the ammonia oxidation catalyst to a position upstream of the selected portion of the water storage material to provide the heated flow of gas.

Alternatively, the heating device may be a heat exchanger arranged to recover heat from gas downstream of the treatment unit, preferably the one or more catalysts. In this embodiment the gas passing out of the ammonia oxidation catalyst is not physically recycled, but it has its heat recovered by the heat exchanger and is used to heat fresh air passing to the selected portion of the water storage material. The heat exchanger may serve as a condensing unit so as to recover heat by condensing the ammonia liberated from the sorbent bed. By using such a heat exchanger, the inventors have found that a further heater upstream of the selected portion of the water storage material is not required such that, preferably, there is no further heater upstream of the selected portion of the water storage material.

The system is configured so that the selected portion of the water storage material changes over time. This means that there is one portion of the water storage material which is being discharged of water, while a remainder (one or more further portions) of the water storage material is being charged with water. Since the selected portion changes over time, each portion will have a first time period when it is charging with water and a second time period when it is discharging the water.

Various configurations of the system can be envisioned whereby the selected portion of the water storage material changes over time. In each instance the selected portion needs to move relative to the supply of heated gas and relative to the external gas outlet arranged downstream of the selected portion of the water storage material. Given the complexity of the ducting and the simplicity of the water storage material (such as a sorbent bed), it will generally be most appropriate to move the water storage material.

A particularly preferred arrangement to allow for the selected portion of the ammonia storage material to change over time is for the water storage material to be configured as a rotating sorbent bed. That is, preferably the water storage material is provided within a sorbent bed which is arranged to rotate so that, in use, different portions of the water storage material are each contacted with a heated gas in turn.

For a rotating sorbent bed, the bed can preferably be configured to rotate continuously at a constant rate. Alternatively, the bed can be configured to rotate stepwise at pre-set, preferably uniform, intervals (a “revolver cylinder” type configuration). Continuous rotation is preferred since this ensures a consistent rate of dehumidifying the exhaust gas and since this reduces wear on the system components. Typical rotation rates, in either rotation configuration, will be in the region of 0.5 to 4 rotations per hour, preferably about 1 rotation per hour. A suitable rotation rate will depend on the humidity of the exhaust gas and the size of the bed and can be tuned to the specific application. A primary consideration is that the wheel needs to rotate at a sufficiently slow rate such that it cools for effective storage of water before it is heated again for water release. Indeed, the rotation rate can be changed on the fly responsive to water levels in the exhaust gas.

Preferably the system further comprises one or more humidity sensors downstream of the remainder of the water storage material, i.e. not downstream of the selected portion, to determine a water loading status. This can be used to control the rotation rate to ensure that water storage material is discharged before it becomes over full.

For a rotating sorbent bed the preferred bed size is such that it has a diameter of from 10 cm to 600 cm, preferably 100 to 450 cm, more preferably 200 to 400 cm, for example 300 cm. Preferably, the sorbent bed has a depth of 5 to 50 cm, preferably 10 to 20 cm. As will be appreciated, the rotating beds can therefore have a significant water storage capacity. The size of the wheel can be scaled down or up depending on a number of factors, for example, the quantity of water (larger animals will generate higher quantities) and the back-pressure generated (which itself will be dependent on a variety of factors, e.g. sorbent depth, fan size). The main factor in the wheel size is the pressure-drop requirements, with larger wheel sizes permitting lower pressure drop requirements, meaning less powerful driving fans are required with an associated lower energy cost. A wheel size of 2-4 m can permit a pressure drop as low as 2 mbar or even 1 mbar.

Gas flow rates through the system would be expected to peak in the region of 100 to 300 km³/h, such as about 200 km³/h, with faster rates required in summer than in winter.

As can be appreciated from a rotating sorbent bed, the bed will have a portion receiving the ambient air from the, for example, a poultry house, at an ambient temperature. This portion of the bed will be efficiently storing water. The selected portion receiving heated gas will be at an elevated temperature as mentioned above, such as 150° C. However, a portion which has just been rotated away from the source of heated gas will take time to cool to ambient temperature. During this period there is an increased risk of water slip leading to the rest of exhaust system and treatment unit.

Preferably, the system comprises means for cooling a previously-heated portion of the water storage material with a supply of ambient air. The ambient air may be ambient exhaust gas, for example from the livestock house. In some embodiments, it is preferred that the ambient air is ambient fresh air. In a particularly preferred embodiment, the supply of ambient air can be coupled with a heat exchanger to allow use of the heat being recovered elsewhere in the system. That is, heat from the previously-heated portion of the water storage material may be recovered through the use of an ambient air flow which is then further heated, preferably using a heat exchanger arranged to recover heat from gas downstream of the treatment unit as described herein, so as to provide the heated gas (i.e. a separate gas stream) which passes through the selected portion of the water storage material. Preferably the previously-heated portion of the water storage material is cooled with a flow counter to the normal direction of gases through the water storage material. This means that the gas flow avoids any ammonia slip, since any water is carried back upstream of the cooling water storage material and is then retained on ambient temperature water storage material. The rotating sorbent bed can comprise a plurality of inserts comprising the water storage material. In such an embodiment the plurality of inserts would be releasably held in a supporting frame structure so as to provide storage material for the exhaust gas to pass through while minimising any gas bypassing the storage material.

Preferably the system further comprises one or more material filters between the humid air inlet and the water storage material. That is, the system comprises filters to perform an initial screen of matter which could affect the performance of the downstream exhaust system. When treating air from a poultry house, such a material filter can be used to remove entrained feathers, fluff, straw, dust and the like.

As discussed above, preferably the system comprises one or more fans to push or pull gases through the system. The configuration of such a fan will depend on the desired air exchange rate required in the atmosphere to be treated. Advantageously the entire system can be driven by a single fan.

### Dehumidifier System

Preferably, the water storage material comprises one or more sorbents selected from silica gel, activated alumina, a zeolite and a metal-organic framework (MOF). As will be appreciated, the water storage material will have greater affinity to water over ammonia so as to accumulate and remove the water from the humid gas. The water storage material may be readily selected by a skilled person so as to preferentially store water over the species to be treated. For example, a small pore zeolite may be preferred for the dehumidifier system where VOCs are treated since a small pore can exclude the VOCs. In a particularly preferred embodiment, the water storage material is an alkali metal loaded zeolite. Alkali metal loaded zeolites (e.g. sodium loaded zeolite) are especially suitable for use in treatment of a humid gas comprising ammonia. Water will typically displace ammonia and alkali metal loaded zeolites have particularly high affinity for water over ammonia permitting storage of water in preference to ammonia. Zeolites generally desorb water at much lower temperatures than ammonia which is also beneficial for reducing ammonia slip during regeneration of the water storage material. Consequently, the water storage material may be selected based on known affinities of the material for water and ammonia.

The heated humidified gas may be released to the atmosphere. In a particularly preferred embodiment, the dehumidifier system further comprises means for recovering heat from the heated humidified gas. Preferably, the means is a heat exchanger and the heat exchanger is used to provide heat to another part of the exhaust system, preferably to provide a flow of heated gas as described herein. Accordingly, in use, the heat exchanger may condense the water in the heated humidified gas so as to recover heat. Cooled liquid water and gases are then released to the atmosphere.

The invention will now be described in relation to the following non-limiting figures, in which:

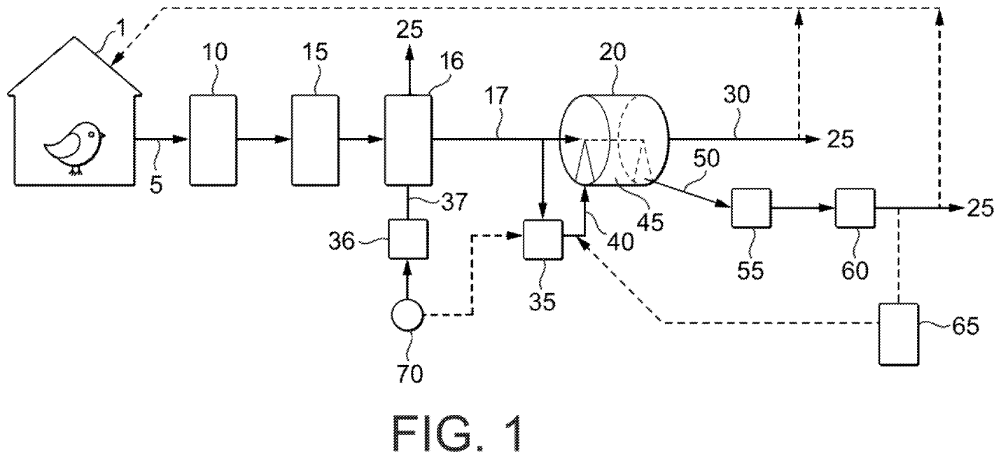

FIG. 1 shows a schematic of an exhaust gas system as described herein.

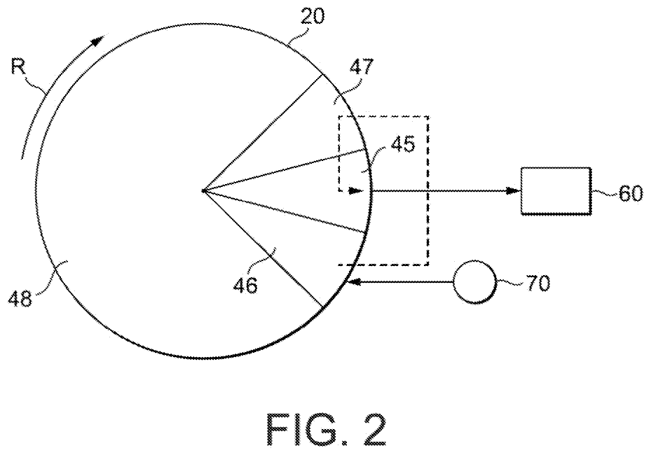

FIG. 2 shows a schematic of a sorbent bed wheel as described herein.

FIG. 1 shows a poultry house 1 provided with an exhaust gas system as described herein. The poultry house 1 provides a source of humid exhaust gas 5 which will typically contain about 20 ppm of ammonia. The humid exhaust gas 5 is passed to a material filter 10 to ensure that any undesirable physical contaminants, such as poultry feathers are removed. The exhaust gas 5 then passes to an H₂S sorbent 15 to ensure that H₂S is removed and does not poison the downstream components of the system.

The humid exhaust gas 5 then passes to a dehumidifier system 16 which comprises a water storage material. The majority of the humid exhaust gas 5 passes directly through the dehumidifier system 16 to provide a flow of dehumidifier exhaust gas 17 which is then directed to a sorbent wheel 20 which comprises ammonia storage material. The majority of the dehumidified exhaust gas 17 passes directly out of the sorbent wheel 20 to the atmosphere 25 as an ammonia-depleted exhaust gas 30, with the ammonia having been stored on the ammonia storage material. The ammonia-depleted exhaust gas 30 typically comprises less than 1 ppm ammonia and preferably essentially no ammonia. A minority of the dehumidified exhaust gas 17 passes through a heater 35, such as a propane burner or a resistive heater coil, to provide a heated dehumidified exhaust gas 40 (around 150° C.).

The heated dehumidified exhaust gas 40 passes through a selected portion 45 of the sorbent wheel 20. Because of the heated dehumidified exhaust gas 40, ammonia absorbed on the sorbent wheel 20 is desorbed. This forms an ammonia-rich gas 50 containing at least 250 ppm ammonia and preferably at least 1000 ppm ammonia. The ammonia-rich gas 50 leaving the selected portion 45 of the sorbent wheel 20 is directed to a further heater 55 and then to an oxidation catalyst 60 for decomposing the ammonia to nitrogen and water before this is released to the atmosphere 25 with levels of ammonia of less than 1 ppm and preferably essentially no ammonia.

The gases released to the atmosphere 25 may instead be returned to the poultry house 1. This allows the heat to be retained in the atmosphere when the ambient temperature in the poultry house 1 is below the outside ambient temperature, reducing heating costs.

Instead or in addition to the heater 35, a heat exchanger 65 can be used to provide the heated exhaust gas 40. Instead or in addition to using a minority of the dehumidified exhaust gas 17 to desorb the ammonia, a source of fresh gas 70, such as fresh air, can be used.

A further heater 36 provides a flow of heated fresh air 37 to the dehumidifier system 16 for releasing water stored on a portion of the water storage material thereby regenerating the water storage material. The heated fresh air 37 produces a heated humidified exhaust gas which is then passed to the atmosphere 25.

Gas recycle routes and some alternatives or optional features/ are shown with dashed lines.

FIG. 2 shows a sorbent wheel 20 and in particular the selected portion 45 which receives the minority of heated exhaust gas 40. As further shown, due to the direction of rotation (R) there will also be a cooling portion 46 and there may be a pre-heating portion 47.

In order to minimise ammonia slip, the cooling portion 46 is desirably cooled with a source of fresh air 70, optionally flowing in a counter-current direction. After passing through the cooling portion 46 the gas may then be allowed to pass freely through the selected portion 45, the pre-heating portion 47 or the remainder portion 48. Alternatively the gas can be directed specifically to the pre-heating portion 47 for energy efficiency. After passing through the pre-heating portion 47, the gases can be further heated with the heat exchanger 65 to then be ducted upstream of the selected portion 45 to provide hot gas for desorbing ammonia. All of this gas flow can be controlled with suitable ducting and, where necessary with driving fans.

Although preferred embodiments of the invention have been described herein in detail, it will be understood by those skilled in the art that variations may be made thereto without departing from the scope of the invention or of the appended claims.

1. An exhaust system for the treatment of a humid exhaust gas comprising ammonia in an amount of up to 250 ppm, the system comprising:
a dehumidifier system comprising a humid air inlet for providing a flow of humid exhaust gas;
an exhaust gas inlet for providing a flow of dehumidified exhaust gas;
an ammonia storage material arranged to receive the dehumidified exhaust gas from the exhaust gas inlet;
an ammonia oxidation catalyst arranged downstream of a selected portion of the ammonia storage material; and
a heating device for heating gas before it passes through the selected portion of the ammonia storage material to release ammonia stored therein for treatment on the ammonia oxidation catalyst;
wherein the system is configured so that the selected portion of the ammonia storage material changes over time; and
wherein the flow of dehumidified exhaust gas provided by the exhaust gas inlet is received from the dehumidifier system.

2. The exhaust system according to claim 1, wherein the dehumidifier system comprises:
a humid air inlet for providing a flow of humid exhaust gas;
a further gas inlet for providing a further flow of heated gas;
a plurality of water-sorbent beds, comprising a water storage material, for releasably storing water;
a further gas outlet in fluid communication with the exhaust gas inlet;
an external gas outlet; and
a dehumidifier valve system configured to establish independently for each water-sorbent bed fluid communication in a first or second configuration, wherein:
i) in the first configuration the flow of the humid exhaust gas from the humid air inlet contacts a water-sorbent bed for storing water and then passes to the further gas outlet; and
ii) in the second configuration the further flow of heated gas from the further gas inlet contacts a water-sorbent bed for releasing the water to form a heated humidified gas which then passes to the external gas outlet;
wherein the dehumidifier valve system is configured to ensure that at least one water-sorbent bed is in the first configuration and, at least one other water-sorbent bed is in the second configuration.

3. The exhaust system according to claim 1, wherein the dehumidifier system comprises:
a humid air inlet for providing a flow of humid exhaust gas;
a water storage material arranged to receive the humid exhaust gas from the humid air inlet;
a further gas outlet for receiving dehumidified exhaust gas passing through the water storage material, which is in fluid communication with the exhaust gas inlet,
an external gas outlet, arranged downstream of a selected portion of the water storage material; and
a further gas inlet for providing a further flow of heated gas arranged to pass through the selected portion of the water storage material to release water stored therein and to form a heated humidified gas which passes through the external gas outlet;
wherein the dehumidifier system is configured so that the selected portion of the water storage material changes over time.

4. The exhaust system according to claim 1, wherein the humid exhaust gas comprises from 1 to 50 ppm ammonia. ammonia.

5. The exhaust system according to claim 1, wherein the heating device is configured to heat the gas before it passes through the selected portion of the ammonia storage material to a temperature of from 50 to 300° C.

6. The exhaust system according to claim 1, wherein the system further comprises one or more material filters between the exhaust gas inlet and the ammonia storage material.

7. The exhaust system according to claim 1, wherein the system comprises an H₂S sorbent material and/or an As sorbent material upstream of the ammonia storage material.

8. The exhaust system according to claim 1, the system comprising means for cooling a previously-heated portion of the ammonia storage material with a supply of ambient air.

9. The exhaust system according to claim 1, the system comprising means for ducting gas from a previously-heated portion of the ammonia storage material to pre-heat a soon-to-be heated portion of the ammonia storage material.

10. The exhaust system according to claim 1, wherein the ammonia storage material is provided within a sorbent bed which is arranged to rotate so that, in use, portions of the ammonia storage material are each contacted with a heated gas in turn.

11. (canceled)

12. The exhaust system according to claim 10, wherein the sorbent bed is configured to rotate stepwise.

13. (canceled)

14. (canceled)

15. The exhaust system according to claim 10, wherein the sorbent bed comprises a plurality of inserts comprising the ammonia storage material.

16. The exhaust system according to claim 1, wherein the heating device is located between the exhaust gas inlet and the ammonia storage material.

17. The exhaust system according to claim 1, wherein the heating device is located between the ammonia storage material and the ammonia oxidation catalyst and wherein the system further comprises a duct for recycling at least a portion of the gas from the ammonia oxidation catalyst upstream of the selected portion of the ammonia storage material.

18. The exhaust system according to claim 1, wherein the heating device is a heat exchanger arranged to recover heat from gas downstream of the ammonia oxidation catalyst.

19. The exhaust system according to claim 18, further comprising a second heating device located between the ammonia storage material and the ammonia oxidation catalyst, wherein the second heating device is configured to heat gas passing to the ammonia oxidation catalyst to 200 to 300° C.

20. The exhaust system according to claim 1, wherein the heating device is supplied with heat obtained from the catalytic treatment of the ammonia, whereby the system can be maintained in an autothermal condition.

21. (canceled)

22. The exhaust system according to claim 2, wherein the dehumidifier system further comprises means for recovering heat from the heated humidified gas.

23. (canceled)

24. A livestock house comprising the exhaust-gas system according to claim 1.

25. A method of treating a humid ammonia-containing exhaust gas, the method comprising passing the humid ammonia-containing exhaust gas through the exhaust-gas system according to claim 1.
